(19) United States
(12) Patent Application Publication
(10) Pub. No.: US 2018/0264570 A1
(43) Pub. Date: Sep. 20, 2018

(54) METHOD AND DEVICE FOR AUTOMATED MACHINING OF GEARWHEEL COMPONENTS

(71) Applicant: Klingelnberg AG, Zürich (CH)

(72) Inventors: Thomas Schenk, Coburg (DE); Olaf Vogel, Ettlingen (DE)

(21) Appl. No.: 15/924,820

(22) Filed: Mar. 19, 2018

(30) Foreign Application Priority Data
Mar. 20, 2017 (EP) 17161882.0

(51) Int. Cl. B23F 23/12; B23F 21/12

(52) U.S. Cl. CPC B23F 23/1218; B23F 21/12

(57) ABSTRACT

A manufacturing environment having a machine tool, a measuring device, a storage medium, and having a computer programmed to control: a) chip producing machining of a first workpiece in a machine tool, b) acquiring at least two machine parameters of the machine tool during the chip producing machining of the first workpiece, c) storing the machine parameters in the storage medium, wherein the storing is performed with assignment to the first workpiece, and d) repeating steps a) to c) for a number of n workpieces; and, after one of steps a) to d), or later, triggering a testing method including: (i) selecting at least one of the workpieces, (ii) performing an automated test of the at least one selected workpiece using the measuring device, or (iii) performing a processor-controlled evaluation of the automated test to classify the at least one selected workpiece as a good part, or a reject part.

### CROSS REFERENCE TO RELATED APPLICATIONS

This application claims priority under 35 U.S.C. §§ 119(a)-(d) to European patent application no. EP 17 161 882.0 filed Mar. 20, 2017, which is hereby expressly incorporated by reference as part of the present disclosure.

### FIELD OF THE INVENTION

The present disclosure generally relates to a method and devices for automated machining of gearwheel components.

### BACKGROUND

It is known that present production and machining sequences are gradually becoming more complex. Above all in series manufacturing, particular attention is applied to reducing the rejects and therefore improving the throughput.

The machining of gearwheels partially takes place in a manufacturing environment which also comprises a measuring machine in addition to the actual machine tool. It is possible to react rapidly if deviations occur by way of a suitable feedback between the measuring machine and the machine tool. These approaches are sometimes referred to as closed-loop methods.

Document DE 102014015587 A1 describes, for example, a dynamic measurement and correction strategy for monitoring and/or correcting a manufacturing process (series manufacturing). This document provides the measurement of machine parameters, to enable inferences about the present manufacturing process on the basis of measured values.

However, it has been shown that the technical relationships are sufficiently complex that a simple, but isolated consideration of individual machine parameters, as is the case in the above-mentioned document, does not provide an answer for establishing setpoint values and/or evaluation criteria.

Specifically, it has been shown that manufacturing-critical operating states which result in reject workpieces can generally not be recognized by an isolated observation of individual machine parameters.

Above all, the causal relationships as to why certain operating states result in suitable or unsuitable workpieces are often not known and are also not comprehensible. Without this knowledge, a corresponding machining method can hardly be reasonably used or even optimized, however.

### SUMMARY

It is therefore an object to provide a device and a corresponding method, which enable the throughput during the automatic machining of gearwheel components to be increased, without having to make compromises in the matter of quality.

The disclosure is directed in this case to the combined observation of two or more than two machine parameters, wherein manufacturing-critical state combinations are made recognizable and usable on the basis of correlations.

According to one aspect, two or more than two machine parameters of this workpiece may be acquired and stored before, during (i.e., on-the-fly or accompanying the process), or after the machining of a workpiece. The machine parameters of multiple machined workpieces are used as the foundation of a knowledge base.

Only a state combination of multiple machine parameters and the ascertainment of correlations enable a reliable and accurate judgment of individual workpieces during or after their machining.

Suitable correlations may be found in the disclosure herein if, in addition to the machine parameters, which are acquired and stored for each workpiece, measurement results, which were acquired in a measuring device or machine, are also stored for at least a part of the workpieces. The consideration together of the machine parameters of a workpiece and the measurement results for this workpiece enables the automated finding of suitable correlations.

Some aspects involve machine parameters which have an indirect relationship to the corresponding workpiece and to concrete measurements on the workpiece itself. In this manner, a database—referred to here as a knowledge base, is built up and made available.

Since an establishment of manufacturing-critical state combinations, which are to result in triggering of measurement and/or correction cycles upon recognition, is difficult to implement by analytical observations because of the complexity, some aspects involve correlation observations and the analysis of large quantities of data.

This knowledge base can be built up and expanded more and more over time. The knowledge base can also be provided at the factory with a fundamental data set, so that the process can already be used from the first machined workpiece.

According to some embodiments, the knowledge base is used accompanying the production, to be able to perform an automated evaluation of workpieces. If such an evaluation has the result that, on the basis of the machine parameters which were acquired for a workpiece just machined, this workpiece is correct with high probability (since, for example, it corresponds to or meets a workpiece specification), this workpiece is thus, for example, classified as a good part. If this workpiece, in contrast, is not correct with high probability, this workpiece is thus either directly classified as a reject part, or it is transferred to a measuring device or machine for the purpose of (surveying) measuring.

Workpieces which cannot be clearly recognized as a good or reject part are transferred in some embodiments to a measuring device or machine for the purpose of (surveying) measuring.

The use of the terms “good part” and “reject part” should not be interpreted narrowly. A reject part as used herein is a workpiece which cannot be used for its intended purpose without correction because it does not achieve a required accuracy requirement (called specification). A reject part is therefore a workpiece which requires a correction intervention. A good part, in contrast, is a workpiece which does not require a correction intervention.

Two different tolerance fields can also be used, as follows. A first larger tolerance field is applied in these embodiments to differentiate between good and reject parts. A second narrower tolerance field is used in these embodiments to differentiate between correction requirement (i.e., a correction intervention is performed in the process) and no correction requirement (i.e., no correction intervention is performed in the process). If the narrower tolerance field is used for the process regulation, a violation of the outer tolerance and/or actual reject parts may never occur.

Carrying out a measuring method in the measuring device or machine is used, on the one hand, to provide clarity in uncertain evaluation situations. In this case, the affected workpiece can be classified finally and unambiguously as a good part or as a reject part. On the other hand, the measuring method is also used to expand the knowledge base. This is achieved in that the machine parameters of a workpiece are combined with the result of the measuring method of this workpiece and then analyzed or processed for later use.

The machine parameters and the results of the measuring method can be used for the purpose of correlation. A search is made automatically for possible correlations on the basis of one or more correlation methods.

In subsequent steps, already present correlations can be further improved (in the sense of reinforced) or rejected.

Evaluation criteria may be derived from the correlations of the knowledge base. These evaluation criteria are then applied in the corresponding manufacturing environment during the machining of further workpieces. In this manner, good parts and reject parts can be differentiated more rapidly and reliably.

A correction method may be applied, which engages if needed in the machining process or which performs adaptations or modifications to the machine tool.

In some embodiments, the active correction values which are presently used during the machining of a workpiece are to be understood as machine parameters. These active correction values may be stored in a knowledge base.

The inventors have found that in the case of an observation of many machine parameters and possibly also multiple evaluation criteria, a full-factorial consideration of all state and evaluation combinations can be very complex. The “knowledge” concealed in the data is also not comprehensible to the operator of a machine tool nor is it to be analyzed by an expert in this form. However, modern methods of data analysis enable knowledge to be made “comprehensible” and therefore also technically usable.

It is thus possible to determine the probability that a specific state combination of specific machine parameters results in a concrete evaluation or evaluation combination. It can then be determined for occurring states or state combinations on the basis of these probabilities whether measurements of a workpiece just machined or whether corrections of the machining method are required.

Vice versa, however, it can also be determined with which probability a specific state combination would be present if a specific evaluation (via measurement or prognosis) were ascertained. This procedure is helpful if correction measures are to be taken solely on the basis of the built-up knowledge base.

Embodiments disclosed herein offer the advantage that the measuring effort is less in comparison to the typical random sample measurement, which takes place at a fixedly defined interval.

Advantageous embodiments of the coordinate measuring device are disclosed herein.

According to one aspect, a method for the automated machining of workpieces includes a) chip producing machining of a first workpiece in a machine tool, b) acquiring at least two machine parameters of the machine tool during the chip producing machining of the first workpiece, c) storing the at least two machine parameters in association with information identifying the first workpiece, e.g., a unique identifier, and d) repeating steps a) through c) for a number of n workpieces. After one of steps a) through d) or later, a testing method is triggered having the following steps: (i) selecting at least one of the n workpieces, (ii) performing an automated test of the selected at least one workpiece, and (iii) performing a processor-controlled evaluation of the automated test adapted to classify the selected at least one workpiece as a good part or a reject part.

In some embodiments, the automated test includes an automated measurement. Some embodiments include performing the automated test using a knowledge base or a databank.

In some embodiments, the method includes performing a correlation computation of the at least two machine parameters of multiple workpieces and the data acquired by the automated measurement of the multiple workpieces, e.g., in order to provide at least one evaluation criterion for the processor-controlled evaluation in the above-discussed step (iii).

In some embodiments, the method includes performing data processing of the at least two machine parameters of multiple workpieces and the data acquired by the automated measurement of the multiple workpieces, e.g., in order to provide at least one evaluation criterion for the processor-controlled evaluation in the above-discussed step (iii) on the basis of correlations.

In another aspect, the method includes performing a processor-controlled correlation between the at least two machine parameters of the selected at least one workpiece and the processor-controlled evaluation of the selected at least one workpiece, and storing the correlation in a databank.

In some embodiments, at least one of the at least two machine parameters includes a mean value during the machining in the above-discussed step a). In other embodiments, at least one of the at least two machine parameters includes an interval defined by a minimum and a maximum during the machining in the above-discussed step a). In yet other embodiments, at least one of the at least two machine parameters includes multiple measured values during the machining in the above-discussed step a).

In some embodiments, the method includes performing the processor-controlled evaluation in the above-discussed step (iii) using a workpiece specification, setpoint data, or at least one evaluation criterion or a combination of evaluation criteria, so as to differentiate the selected at least one workpiece as a good part or a reject part.

In some embodiments, the selection of the workpieces includes selecting all of the workpieces, selecting a subset of the workpieces, selecting during a first period of time, a number of the workpieces so as to build up a databank and, during a second period of time after the first period of time, selecting a smaller number of the workpieces than selected during the first period of time, or selecting an workpiece that existing data in a database indicates could qualify as a reject part.

According to another aspect, the method includes periodically performing a computer analysis using a databank or a storage medium, so as to process a quantity of data stored in the databank or the storage medium for more rapid access thereto. In some embodiments the computer analysis includes a correlation analysis. In another embodiment, the method further includes triggering and performing a correction method that includes performing adaptations applied during automated machining of subsequent workpieces. In some embodiments, the correction method is triggered by software, the machine tool, and/or a measuring device or measuring machine.

In another aspect, a manufacturing environment or device includes at least one machine tool, at least one measuring device or measuring machine, at least one databank or storage medium, and a computer or processor. The computer or processor is programmed to control the following performed by the manufacturing environment: a) chip producing machining of a first workpiece in the at least one machine tool, b) acquiring at least two machine parameters of the at least one machine tool during the chip producing machining of the first workpiece, c) storing the at least two machine parameters in the at least one databank or storage, and d) repeating steps a) through c) for a number of n workpieces. After one of steps a) through d) or later, a testing method is triggered having the following steps: (i) selecting at least one of the workpieces, (ii) performing an automated test of the selected at least one workpiece with the measuring device or measuring machine, and (iii) performing a processor-controlled evaluation of the automated test adapted to classify the selected at least one workpiece as a good part or a reject part. In some embodiments, the automated test includes an automated measurement. Some embodiments include performing the automated test using a knowledge base, which can be or include the at least one databank or storage medium.

Other objects, features, and/or advantages will become apparent in view of the following detailed description of the embodiments and the accompanying drawings.

However, while various objects, features and/or advantages have been described in this summary and/or will become more readily apparent in view of the following detailed description and accompanying drawings, it should be understood that such objects, features and/or advantages are not required in all aspects and embodiments.

This summary is not exhaustive of the scope of the present aspects and embodiments. Thus, while certain aspects and embodiments have been presented and/or outlined in this summary, it should be understood that the present aspects and embodiments are not limited to the aspects and embodiments in this summary. Indeed, other aspects and embodiments, which may be similar to and/or different from, the aspects and embodiments presented in this summary, will be apparent from the description, illustrations and/or claims, which follow.

It should also be understood that any aspects and embodiments that are described in this summary and do not appear in the claims that follow are preserved for later presentation in this application or in one or more continuation patent applications.

### BRIEF DESCRIPTION OF THE DRAWINGS

Other advantages and features will become apparent from the following detailed description, which are to be understood not to be limiting and which will be described in greater detail hereafter with reference to the drawings, wherein:

FIG. 1 shows a schematic view of a chip-removing machine, a measuring machine, and a computer, wherein the mentioned components have communication connections to one another;

FIG. 2 shows a schematic flow chart which represents the features of a process;

FIG. 3 shows a schematic, exemplary temperature-time diagram, which was recorded during the chip producing machining of a workpiece W.1 as a machine parameter;

FIG. 4 shows a schematic, exemplary frequency-time diagram, which was recorded during the chip producing machining of the workpiece W.1 of the embodiment illustrated in FIG. 3 as a further machine parameter;

FIG. 5 shows a schematic diagram having exemplary machine parameters, wherein a first machine parameter P1 was divided into three groups A, B, and C and a second machine parameter P2 was divided into two groups 1 and 2, and the machine parameters were assigned to these groups;

FIG. 6 shows a schematic flow chart which expands on FIG. 2 and illustrates the features of a further process;

FIG. 7 shows a schematic flow chart which expands on FIG. 2 and FIG. 6 and illustrates the features of a further process.

### DETAILED DESCRIPTION

Terms are used in conjunction with the present description which are also used in relevant publications and patents. However, it is to be noted that the use of these terms is merely to serve for better comprehension. The concept of the invention and the scope of protection of the patent claims are not to be restricted in the interpretation by the specific selection of the terms. The invention may be readily applied to other term systems and/or technical fields. The terms are to be applied accordingly in other technical fields.

The present disclosure relates to, inter alia, chip-removing machines M.m, as are used, for example, in the machining of gearwheel workpieces. The reference sign M.m is to indicate that the device and/or method can be used in a manufacturing environment 100, which can comprise at least two structurally-identical chip-removing machines M.m or two different chip-removing machines M.m. Here, m is an integer greater than or equal to one.

Some embodiments of the present disclosure have been designed and optimized in particular for use in a manufacturing environment 100 for machining gearwheels.

The term “measuring machine” is used here for separate machines. The term “measuring device,” in contrast, is to indicate that this device can be, for example, integrated into the machine M.m or can be attached thereon.

“Software SW” refers here to a code sequence which is executable directly by a computer or processor, or which has to be converted into a machine code before the execution, to then be able to be executed by the computer or processor. The software SW can be provided in some embodiments as a software product (for example, as application software), which is installed, for example, on a computer before the execution. The software SW can also be constructed modularly and/or installed at multiple locations (for example, in the computer 10, the machine M.m, and the measuring machine 20), for example.

The term “computer 10” represents here a microprocessor-controlled device, for microcomputers, processor-controlled facilities or facility parts, for a machine controller, and also for computers which can be embodied, for example, separately from the machine M.m.

Variables, values, or items of information which each have a reference to a workpiece W.n and were acquired in or on the machine M.m are considered as machine parameters Mp_{W.n}. A listing of several examples is provided hereafter, wherein this listing is not complete:

temperature at one or more points of the machine M.m,

temperature of the workpiece W.n,

ambient conditions (for example, temperature, air pressure, ambient humidity, solar radiation on the machine M.m, etc.)

speed of a spindle of the machine M.m,

position and/or movement of individual axes of the machine M.m,

load or strain of individual axes of the machine M.m,

imbalance of a spindle of the machine M.m,

eccentricity,

structure-borne noise (for example, for absorbing vibrations),

power consumption of the drive of an axis of the machine M.m,

torque.

Process-accompanying parameters can also be used as machine parameters Mp_{W.n} here, for example, the number of starts of the machine M.m since the production or shift beginning, the progressing number n of the machined workpieces W.n (for example, since the last tool change), etc.

The machine parameters Mp_{W.n} are individual specifications which are associated with the workpiece W.n. These are specifications which only have an indirect reference to the workpiece W.n, however, since they contain a state information item, for example, the temperature of the workpiece W.n, or the like.

The machine parameters Mp are identified here with Mp_{W.n}, to indicate that they have a reference to the respective workpiece W.n. This reference can be provided in some embodiments, for example, by a unique identification (unique ID or uID) of the workpiece.

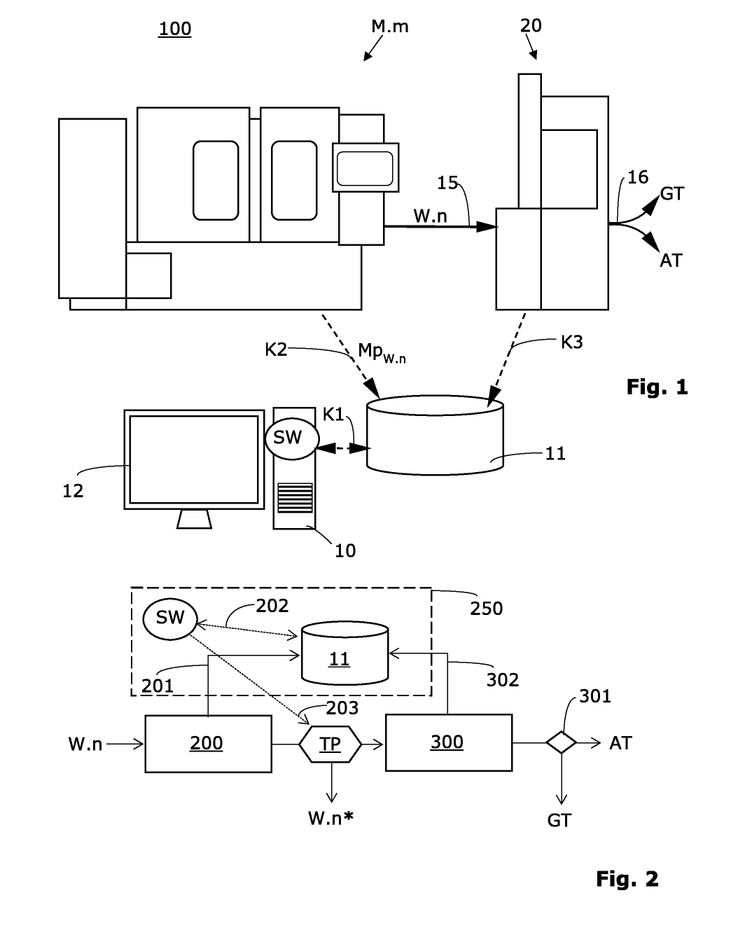

An advantageous embodiment of the invention will be described hereafter on the basis of FIGS. 1 and 2. FIG. 1 shows, in schematic form, an exemplary device 100, which comprises here a first chip-removing machine M.m, a measuring machine 20, and a computer 10. Before further details are described, it is to be noted that in FIG. 1, the communication connections are illustrated as dashed arrows and the handling units or means, which are used, for example, for the transfer of a workpiece W.n, are illustrated as thick solid arrows.

In FIG. 2, in contrast, method steps and branches of the method are shown as solid arrows. The higher-order monitoring or influence, which is exerted in the exemplary embodiment of FIG. 2, for example, by software SW, is illustrated by dotted arrows.

It relates here to production-accompanying processing of data and items of information to make the technical sequence of the machining process 200 more efficient, reduce the rejects, and optimize the manufacturing.

The actual machining (method 200) of workpieces W.n is therefore only a partial aspect of the process.

Concretely, it relates here to methods 200 for automated, chip-removing machining of multiple workpieces W.n, wherein n is an integer greater than or equal to two. The method 200 comprises the following steps, wherein the steps can be executed at least partially simultaneously or chronologically overlapping:

a) The chip producing machining of a first workpiece W.n takes place in a machine tool M.m (see FIG. 1).

b) During this machining of the first workpiece W.n, at least two machine parameters Mp_{W.n} of the machine tool M.m are acquired, which can be performed in some embodiments, for example, using sensors of the machine tool M.m and/or using external means.

c) In a further step, these machine parameters Mp_{W.n} are stored with assignment to the first workpiece W.n. The machine parameters Mp_{W.n} can be stored in some embodiments, for example, in a central databank 11. The reference sign 11 is used here both for the databank and also for the storage medium, since the actual organization and partitioning is unimportant. It is self-evident that the machine parameters Mp_{W.n} can also be stored at various locations and/or in various storage media. In FIG. 1, the transfer of the machine parameters Mp_{W.n} for the purpose of storage is illustrated by the communication connection K2.

d) These steps a)-c) are repeated (for example, in the context of a series production) for a number of n workpieces W.n. The machining of one workpiece W.n is illustrated in FIG. 2 by the block 200 and the transfer of machine parameters Mp_{W.n} for the purpose of storage is illustrated by the arrow 201.

According to one aspect, after one of steps a)-d), or at a later time, carrying out a measuring method 300 is triggered, which comprises at least the steps M1-M3 described hereafter. In FIG. 1, a workpiece W.n is accordingly transferred from the machine tool M.m to a measuring machine 20. The transfer (illustrated by the arrow 15) of the workpiece W.n can take place manually or automatically (for example, by a conveyor system or by a robot).

FIG. 2 shows a trigger point TP, which is to be understood as a type of shunt or branch. This trigger point TP is to illustrate in the flow chart that a workpiece W.n is either transferred after the machining 200 to a measuring method 300, or it is removed from the production as an untested workpiece W.n*. This point will be discussed again later. The trigger point TP can be monitored and/or switched in some embodiments, for example, by the software SW, as indicated in FIG. 2 by the arrow 203.

Steps M1-M3 will be described in greater detail hereafter, wherein reference is also made here to exemplary FIGS. 1 and 2.

M1. At least one of the workpieces W.n is selected, for which previously at least two machine parameters Mp_{W.n} were acquired and stored. This selection can take place immediately after the chip producing machining (method 200) of the workpiece W.n, however, it is also possible to transfer the workpiece W.n, for example, into a temporary store and then to select it later.

M2. An automated test (for example, a measurement 300 or a test on the basis of a knowledge base) of at least this one selected workpiece W.n is carried out in the measuring machine 20.

M3. After or during the testing, a processor-controlled evaluation is performed to be able to classify the selected workpiece W.n into one of at least two groups. The selected workpiece W.n may be classified after the automated test as a good part GT or as a reject part AT. This classification is illustrated in FIG. 1 by two branching arrows 16. In FIG. 2, a diamond 301 indicates that the workpieces W.n are classified after the automated test 300 as a good part GT or as a reject part AT. If an automated measurement is performed as the automated test, the measurement result(s) of the measurement 300 can be stored in a databank 11, as illustrated in FIG. 1 by the communication connection K3 and in FIG. 2 by the arrow 302.

The software SW can form a type of metalevel 250 in some embodiments together with the databank 11, as indicated in FIG. 2, which is superior to the actual machining method 200 and/or the testing or the measuring method 300.

In some embodiments, as shown in FIG. 2 by the double arrow 202, the software SW can store data in the databank 11, organize it (for example, by means of data mining or suitable correlation methods), and/or load data from the databank 11.

The machining method 200 and/or the measuring method 300 can be independent in some embodiments from the process, which is used to perform targeted interventions or adaptations, to exhaust the optimization potential.

The basic principle will be described on the basis of the two FIGS. 1 and 2. Further details will be clarified and exemplary embodiments will be explained hereafter.

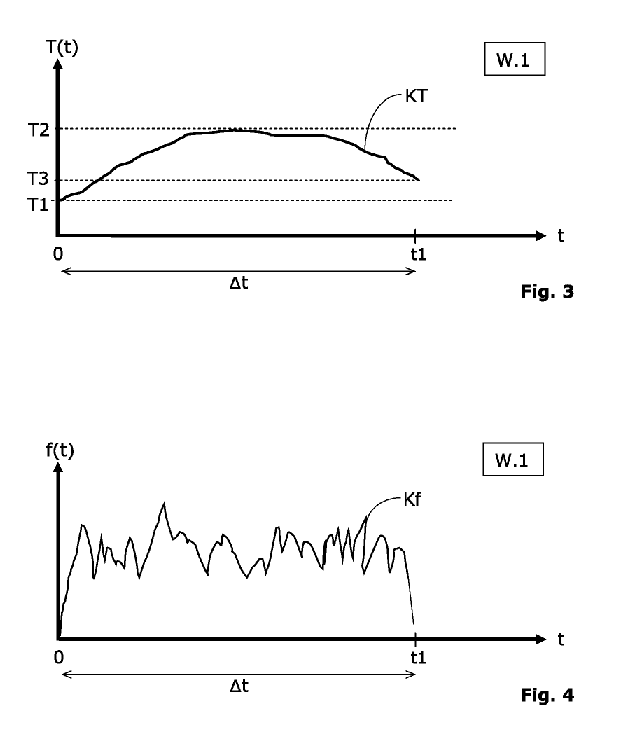

As already mentioned, at least two machine parameters Mp_{W.n} of the machine tool M.m may be acquired during the machining of a workpiece W.n (the workpiece W.1 here). The time curve of two exemplary signals, which were acquired during the machining of the workpiece W.1, is shown by the embodiment illustrated in FIGS. 3 and 4. These two signals were recorded synchronously in time.

FIG. 3 shows the temperature curve T(t), which results during the chip producing machining of the workpiece W.1, for example, on the workpiece spindle of the machine M.m. The machining begins at the time t=0 and ends at the time t=t1. The machining duration is Δt=t1−0. The temperature curve T(t), which is illustrated here by a curve KT, begins at a temperature T1 and reaches a maximum T2 after approximately half of the machining time. The temperature decreases slightly thereafter. The workpiece W.1 leaves the machine M.m having a final temperature T3, which is somewhat higher than the original temperature T1.

FIG. 4 shows a frequency signal f(t), which was measured by means of an oscillation sensor during the chip producing machining of the workpiece W.1, for example, at the tool spindle of the machine M.m. The frequency signal f(t), which is illustrated here by a curve Kf, begins and ends at 0 Hz. The signal displays strong variations. The frequency signal f(t) contains oscillations and other vibrations of the machine M.m.

These exemplary signals T(t) and f(t) may be processed or analyzed (e.g., by a processor and/or a software module), before they are stored in the databank 11. This point can be critical, since one runs the risk during the processing or analysis of losing important items of information which are “contained” or coded in the signals. On the other hand, this is not real time monitoring of a machining method here, however. Rather, it relates to the collection of characteristic machine parameters Mp_{W.n} during the machining of multiple workpieces W.n, to enable a production-accompanying evaluation in this manner.

In the case of a temperature signal as shown, for example, by the curve KT of FIG. 3, it can be sufficient if the mean value K̅T̅ is computed from the curve KT according to a suitable computing rule. If the temperature T in the machine M.m rises in the course of the chip producing machining of multiple workpieces W.1, W.2, W.3, etc., this would be recognized on the basis of a rise of the mean values.

In the case of a frequency signal, as shown, for example, by the curve Kf of FIG. 4, there are numerous options for processing and/or analysis. For example, a conversion of the time signal f(t) into a frequency range can be performed. If one wishes, for example, to ascertain interfering variables (for example, an imbalance of the workpiece spindle of the machine M.m), already known frequency bands can thus be filtered out in the time range, for example, to blank out signal components and exclude them from later consideration, for example, which unambiguously originate from electric motors of the machine M.m, for example. To now acquire interfering vibrations, for example, after a suitable (Fourier) transform, the harmonics can be analyzed and the result of the analysis can be stored.

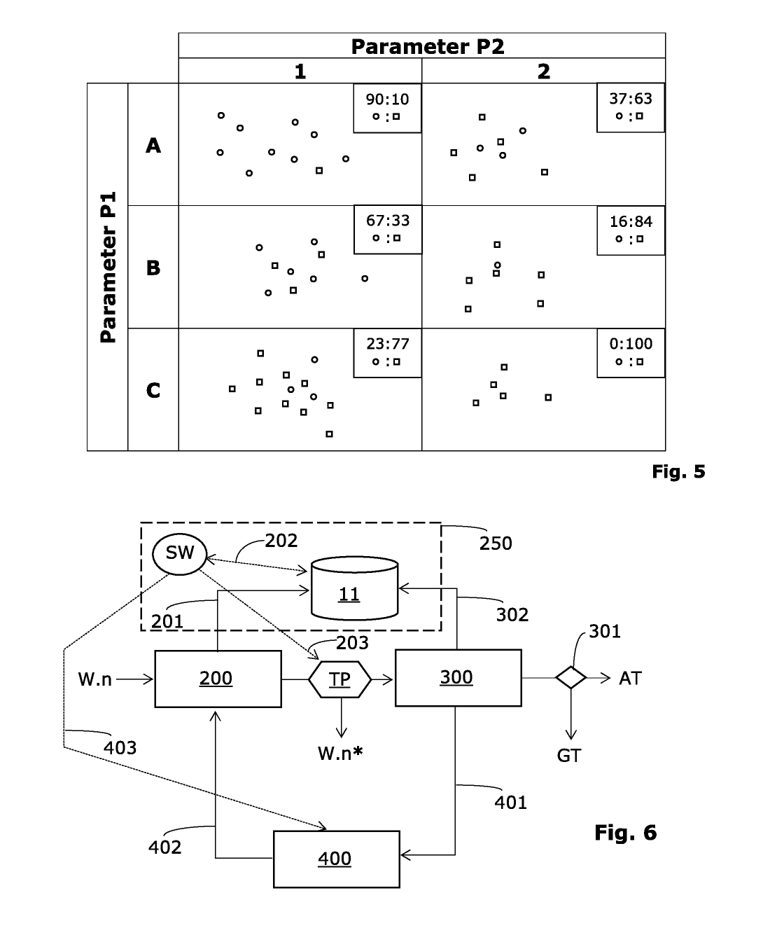

FIG. 5 shows a schematic diagram having two exemplary machine parameters, wherein a first machine parameter P1 was divided into three groups A, B, C and a second machine parameter P2 was divided into two groups 1 and 2. These groups can also be considered as state intervals. The various workpieces W.n were divided into the groups good parts GT and reject parts AT (a division into other groups can also take place here). To be able to visually differentiate the good parts GT from the reject parts AT, they are shown in the form of circles (for GT) and squares (for AT). During the evaluation and classification of the machine parameters, only a single evaluation criterion BK was used here, which enables the affected workpieces W.n to be divided into good parts GT and reject parts AT.

The various state combinations correspond in the example of FIG. 5 to the state boxes shown therein (fields in the tabular graphic of FIG. 5). Each of the state boxes can, for example, correspond to a number of the good parts GT and reject parts AT falling therein. The state box A1 contains, for example, 90% good parts GT. The state box C2 contains, for example, 100% reject parts AT.

In the case of such an assignment, there can be, for example, state boxes, in which only a few or no workpieces at all fall (see state box C2).

The more measured (evaluated) workpieces W.n are provided for a state box, the better can a statement be predicted about the instantaneous manufacturing quality for a concrete state of the machine M.m (which is in turn recognizable on the basis of the machine parameters), which falls in this state box.

The resolution of the value ranges into intervals can be selected coarsely at the beginning and can be adaptively refined in the course of the data acquisition. Thus, for example, a constant ratio of 40:60 can result in a state box, which is unfavorable for evaluations of workpieces W.n, while a division could result in a ratio of 80:20 in one new state box and 10:90 in the other. Such a refinement of the division of state boxes does not always have to result in an improved evaluation, however.

In some embodiments, a fine resolution of the state boxes can also be specified from the beginning, which is then adaptively coarsened in the course of the data acquisition (after measurement of further workpieces W.n) by combination of adjacent state boxes with identical information.

The evaluation and/or division described in conjunction with FIG. 5 is to be understood as an exemplary correlation between state combinations and evaluations (evaluation combinations). There are numerous other options for the correlation of the various machine parameters with the measurement results of the measuring method 300. The word “correlation” is used here to mean the recognition of relationships between the various machine parameters and measurement results. However, in practice these are not simple relationships, but rather relationships which can be very complex. The disclosed processes may be used for finding and applying causal relationships, because especially such relationships enable checkable conclusions to be made or statements to be made, for example, with respect to the quality to be expected of a workpiece W.n just machined (this step is referred to here as the evaluation of workpieces W.n).

The goal of a suitable correlation is to advantageously make causal relationships visible and/or usable by processor-controlled evaluation.

In some embodiments, however, a correlation can also be used to be able to make, for example, a statement about the direction of a relationship (for example, of a positive correlation: if the temperature T2 is higher in the embodiment illustrated in FIG. 3, the maximum frequency of the embodiment illustrated in FIG. 4 is then also higher).

Criteria for the evaluation (called evaluation criteria BK) of the quality of a manufactured workpiece W.n can be defined on the basis of the state combination of the machine parameters acquired during its machining with the aid of a suitable correlation.

In some embodiments, a division into more than two groups can take place and/or multiple evaluation criteria BK can be used.

The following correlation methods may be used, for example, for finding a suitable correlation:

complete multidimensional assignment;

usage of mathematical aids of correlation analysis in (large) data quantities, for example, formal concept analysis for the identification of “concepts” (typical assignments of state combinations to evaluation combinations).

Various approaches are possible for the selection of the workpieces W.n to be measured. A selection on the basis of one of the following strategies may be applied:

Every workpiece W.n, which has previously passed through steps a) to c), is selected to be subjected to the measuring method 300. It is a disadvantage of this approach that the time and cost expenditure is high. This approach may therefore be applied at the beginning, to be able to provide a sufficiently large database in the databank 11 as rapidly as possible.

A subset of all workpieces W.n which have previously passed through steps a) to c) is selected to be subjected to the measuring method 300, wherein the subset may be specified by software SW or by a user.

During a first period of time Δ1, which is used to build up the databank 11, a larger number of the workpieces W.n, which have previously passed through the steps a) to c), is selected (for example, every second workpiece), than during a second period of time Δ2, which lies chronologically after the first period of time Δ1. During the second period of time Δ2, for example, only every tenth workpiece is then subjected to a measurement 300, for example. During the second period of time Δ2, the advantages of the disclosed methods are apparent, since their use enables problems to be recognized early in spite of a small number of concrete measurements 300. For example, if a state combination occurs which clearly indicates that the workpiece just machined probably will not correspond to the specification (this is the case in FIG. 5, for example, in the state boxes B2 and C2), thus, for example, one of the following measures—or combination of at least two of these measures—can be taken:
p1: interrupting the machining of the affected workpiece,
p2: correcting the machining of the affected workpiece,
p3: transferring the affected workpiece to a finish machining device,
p4: performing corrections on the machine before further workpieces W.n are machined.

These measures primarily relate to the actual machining of the workpiece(s) W.n, or the machine M.m, respectively.

The following measures relate to the measuring method 300, which is carried out in a measuring device 20 of the machine M.m or in a measuring machine 20:
p5: adapting the measuring strategy,
p6: changing a setting of the measuring device (for example, readjusting).

The mentioned measures p1 to p6, which are to be understood as examples, can also be combined with one another in any suitable combinations.

Furthermore, the selection can take place on the basis of the following strategies:

A workpiece W.n, which has previously passed through steps a) to c), is selected, for example, if already provided data from the databank 11 indicates that the affected workpiece W.n could be qualified as a reject part AT.

However, it is also possible to perform the selection of workpieces W.n on the basis of the accumulated knowledge of the databank 11. This will be explained hereafter using the example of FIG. 5. If it results during the recording and analysis of the machine parameters Mp_{W.n} of a workpiece W.n that it falls, for example, in the state box A2, an accurate evaluation of the workpiece W.n is thus not possible, since approximately 37% of the workpieces W.n in this state box A2 are good parts GT and 63% are reject parts AT. Since an unambiguous evaluation is not possible in this case, this component is subjected to a measuring method 300. In this manner, on the one hand, the affected component can be definitively classified as a good part GT or as a reject part AT. Moreover, the measurement of this workpiece W.n supplies direct specifications to expand the database of the databank 11. The additional data which is successively acquired in this manner can have the result, for example, that, as mentioned above, the state box A2 is divided into two partial boxes, to be able to make more accurate decisions in the future.

A higher-order goal in the selection of workpieces W.n which are subjected to the measuring method 300 is to expand the database 11 and thus to improve the decision accuracy on the basis of judgment criteria BK.

A further goal is the optimization of the overall machining process. Such an optimization is achieved in that an accurate differentiation is possible on-the-fly, for example, of good parts GT and reject parts AT.

In addition, the disclosed processes and methods, if used in a manufacturing environment 100, produces fewer rejects, since problems are already recognizable during the machining of workpieces W.n. In relation to conventional methods, in which production deviations or errors are sometimes only recognized when a workpiece is routinely measured later, a manufacturing environment 100 equipped accordingly can react more directly and therefore more rapidly.

The system may be designed so that it not only exerts a monitoring function in a manufacturing environment 100, but rather it also enables an intervention in the manufacturing environment 100.

Such an intervention can be performed as follows. It is decided on the basis of at least one correction criterion KK whether an intervention is necessary. A possible correction criterion KK can be linked, for example, to the assignment of the machine parameters Mp_{W.n} of a workpiece W.n just acquired. If, for example, the affected workpiece W.n falls into a state box which has a probability of greater than 80% (for example, the state box B2 of FIG. 5), that it is a reject part AT, a correction method 400 can thus be triggered.

FIG. 6 shows a corresponding embodiment. FIG. 6 builds on FIG. 2. Reference is therefore made to the description of FIG. 2. In addition to the elements, modules, or function blocks of FIG. 2, the embodiment illustrated in FIG. 6 comprises a function block 400, which symbolizes the correction method 400. A workpiece W.n, whose machine parameters Mp_{W.n} fall in the state box B2 of FIG. 5, for example, is immediately subjected to a measuring method 300. As can be seen in the embodiment illustrated in FIG. 6, the correction method 400 is then supplied via the connection 401 with (measurement) data of the measuring method 300. The correction method 400 then intervenes in the machining method 200, for example, by specifying a correction or compensation value for the machine M.m. The specification of a correction or compensation value is illustrated in FIG. 6 by the connection 402.

The correction method 400 can be triggered and/or monitored by the software SW, as shown in FIG. 6. The triggering of the correction method 400 is illustrated in FIG. 6 by the arrow 403.

The correction method 400 can also be triggered and/or monitored, for example, by the machine M.m and/or by the measuring device 20.

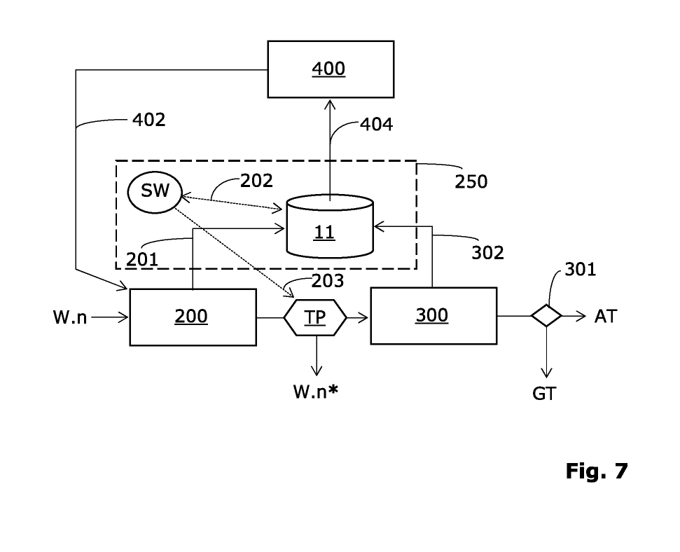

FIG. 7 shows another embodiment, in which the correction method 400 is triggered/operated on the basis of the built-up knowledge base of the databank 11. In the embodiment illustrated in FIG. 7, which in turn builds on FIGS. 2 and 6 and the description thereof, this is illustrated by the arrow 404, which extends from the databank 11 to the correction method 400. The arrow 404 is only to be understood as illustrative, however, since the databank 11 per se does not trigger any actions. The databank 11 contains the collection of the previously-acquired data. The software SW, for example, can be used as the higher-order intelligence in an embodiment according to FIG. 7. The software SW recognizes, on the basis of data which are in the databank 11, whether and in which manner a correction of the machining method 200 is required. The arrow 402 illustrates the performance of the correction.

As may be recognized by those of ordinary skill in the pertinent art based on the teachings herein, numerous changes and modifications may be made to the above-described and other embodiments without departing from the spirit and/or scope of the invention. Accordingly, this detailed description of embodiments is to be taken in an illustrative as opposed to a limiting sense.

What is claimed is:

1. A method for the automated machining of workpieces, comprising the following steps:
a) chip producing machining of a first workpiece in a machine tool,
b) acquiring at least two machine parameters of the machine tool during the chip producing machining of the first workpiece,
c) storing the at least two machine parameters in association with information identifying the first workpiece,
d) repeating steps a) through c) for a number of n workpieces; and
after one of steps a) though d), or at a later time, triggering a testing method comprising the following steps:
(i) selecting at least one of the n workpieces,
(ii) performing an automated test of the selected at least one workpiece, and
(iii) performing a processor-controlled evaluation of the automated test adapted to classify the selected at least one workpiece as a good part or a reject part.

2. The method according to claim 1, wherein the automated test includes an automated measurement.

3. The method according to claim 1, including performing the automated test using a knowledge base or a databank.

4. The method according to claim 2, further including performing a correlation computation of said at least two machine parameters of multiple of said number of n workpieces and data acquired by said automated measurement of said multiple of workpieces, said correlation computation adapted to generate at least one evaluation criterion for the processor-controlled evaluation of method step (iii).

5. The method according to claim 2, further including data processing said at least two machine parameters of multiple of said number of n workpieces and data acquired by said automated measurement of said multiple of workpieces, said data processing adapted to generate at least one evaluation criterion for the processor-controlled evaluation of method step (iii) on the basis of correlations.

6. The method according to claim 1, further including the step of (iv) performing a processor-controlled correlation between the at least two machine parameters of the selected at least one workpiece and the processor-controlled evaluation of the selected at least one workpiece and storing said correlation in a databank.

7. The method according to claim 1, wherein
at least one of the at least two machine parameters includes a mean value during said machining in step a), or
at least one of the at least two machine parameters includes an interval defined by a minimum and a maximum during said machining in step a), or
at least one of the at least two machine parameters includes multiple measured values during said machining in step a).

8. The method according to claim 1, including performing the processor-controlled evaluation in step (iii)
using a workpiece specification, or
using setpoint data, or
using at least one evaluation criterion or a combination of evaluation criteria, so as to differentiate the selected at least one workpiece as a good part or a reject part.

9. The method according to claim 2, wherein the selecting step includes one of:
selecting all of the n workpieces;
selecting a subset of the n workpieces;
selecting, during a first period of time, a number of the n workpieces so as to build up a databank and, during a second period of time that is chronologically later than the first period of time, selecting a smaller number of the n workpieces than selected during the first period of time; or
selecting an n workpiece that existing data in a database indicates could qualify as a reject part.

10. The method according to claim 1, further including periodically performing a computer analysis using a databank or a storage medium so as to process a quantity of the data which is stored in the databank or the storage medium for more rapid access thereto.

11. The method according to claim 10, wherein the computer analysis includes a correlation analysis.

12. The method according to claim 1, further including triggering and performing a correction method that includes performing adaptations applied during automated machining of subsequent workpieces.

13. The method according to claim 12, wherein the correction method is triggered by one or more of software, the machine tool, or a measuring device or measuring machine.

14. A manufacturing environment comprising:
at least one machine tool,
at least one measuring device or measuring machine,
at least one databank or storage medium, and
a computer or processor programmed to control the following performed by the manufacturing environment:
a) chip producing machining of a first workpiece in the at least one machine tool,
b) acquiring at least two machine parameters of the at least one machine tool during the chip producing machining of the first workpiece,
c) storing the at least two machine parameters in the at least one databank or storage medium in association with information identifying the first workpiece,
d) repeating steps a) through c) for a number of n workpieces; and
after one of steps a) through d), or at a later time, triggering a testing method comprising the following steps:
(i) selecting at least one of the n workpieces,
(ii) performing an automated test of the selected at least one workpiece with the measuring device or measuring machine, and
(iii) performing a processor-controlled evaluation of the automated test adapted to classify the selected at least one workpiece as a good part or a reject part.

15. The manufacturing environment according to claim 14, wherein the automated test includes an automated measurement.

16. The manufacturing environment according to claim 14, wherein the automated test uses a knowledge base.

17. The manufacturing environment according to claim 16, wherein the knowledge base is defined by the at least one databank or storage medium.
